(19) United States
(12) Patent Application Publication
(10) Pub. No.: US 2024/0261802 A1
(43) Pub. Date: Aug. 8, 2024

(54) VACUUM CENTRIFUGE AND METHOD

(71) Applicant: ANDREAS HETTICH GmbH & CO. KG, Tuttlingen (DE)

(72) Inventor: Ulrich MASSING, Merzhausen (DE)

(21) Appl. No.: 18/566,569

(22) PCT Filed: Jun. 2, 2022
(86) PCT No.: PCT/EP2022/065132

§ 371 Date: Dec. 1, 2023

(30) Foreign Application Priority Data
Jun. 2, 2021 (DE) 10 2021 114 370.5

(51) Int. Cl. B04B 15/08; B01D 3/08; B01D 3/10; B04B 5/02; B04B 9/02; B04B 9/08; B04B 9/12; B04B 11/04; B04B 15/04

(52) U.S. Cl. CPC B04B 15/08; B01D 3/08; B01D 3/10; B04B 5/02; B04B 9/02; B04B 9/12; B04B 11/04; B04B 15/04; B04B 2009/085

(57) ABSTRACT

A vacuum centrifuge (10) has a housing (15) and a vacuum chamber (14a) which is disposed in the housing (14) and is connected to a vacuum pump (26) via a suction line system (24, 48) in order to generate a required vacuum in the vacuum chamber (14a). The vacuum centrifuge (10) has a rotor (12), mounted rotatably about its rotor axis (12a) in the vacuum chamber (14a) and provided with sample container receptacles (64) for introducing sample containers (66) into the sample container receptacles (64). The vacuum centrifuge (10) also comprises a cover (16) disposed on the housing (14), closes the vacuum chamber (14a) in a vacuum-tight manner and, in the open state, frees the rotor (12) to enable loading and unloading of the rotor (12) with sample containers (66). Only one drive motor (52a) is provided for the rotor (12), disposed outside the vacuum chamber (14a) and coupled to the rotor (12) in the vacuum chamber (14a) to transmit the driving torque as part of a first drive mechanism. The rotor (12) is designed as a rotor of a dual centrifuge.

This application is a national stage application filed under 35 U.S.C 371 of International Application No. PCT Application No. PCT/EP2022/065132 filed on Jun. 2, 2022. The disclosure of the above-referenced application is incorporated herein by reference in its entirety.

The invention relates to a vacuum centrifuge of the type specified in the preamble of claim 1, a method for operating this vacuum centrifuge, as specified in claim 19, as well as a method for removing liquids from samples held in sample containers, as specified in claim 22.

Using vacuum centrifuges already known in the art, liquids are removed from biological, organic or inorganic samples in sample containers by evaporation. Evaporating the liquids under vacuum using a vacuum centrifuge has the advantage that the boiling temperature of the liquids is reduced by the vacuum. This means that the liquid evaporates at a lower temperature, so that the biological, organic or inorganic samples are not affected at all, or at least to a lesser extent. In addition, the liquids evaporate more quickly. The centrifugal forces that occur during vacuum centrifugation counteract the so-called foaming of the samples. Such foaming often occurs when the sample has been heated to boiling temperature or close to boiling temperature, especially if there are undissolved substances in the liquid or if dissolved substances begin to precipitate or crystallize above a certain concentration.

A typical vacuum centrifuge, as is disclosed for example in U.S. Pat. No. 4,226,669 B, has a rotor arranged in a vacuum-tight vessel, which rotor is provided with sample container receptacles into which sample containers with samples can be introduced for centrifugation. Using an appropriate seal, the vessel can be sealed vacuum-tight with a cover. The vessel is evacuated for vacuum centrifugation until the desired negative pressure is set. In order to ensure a vacuum-tight seal between the vessel and the rotor arranged inside it, the rotor is magnetically coupled to a motor outside the vessel via a magnetic coupling, for example, so as to drive the rotor in the vessel. The vessel can also be equipped with a radiant heater to control the temperature of the rotor and of the samples contained inside it. Among other things, radiant heaters are known, such as light with a high IR component, which radiate through a transparent cover into the vacuum chamber containing the samples.

The samples normally consist of liquids in which socovers are dissolved and/or dispersed. The liquids can be volatile or semi-volatile organic solvents, water, or a mixture of the above, which are vaporized in a vacuum. After filling the sample containers, such as test tubes or plastic vials, with the samples, these are placed in the rotor of the vacuum centrifuge, rotation is started and the desired vacuum is created inside the centrifuge vessel. The vessel is continuously evacuated with a vacuum pump in order to remove the evaporated liquid from the vessel and maintain the desired vacuum despite the evaporation. During centrifugation, the solvents and/or the water evaporate and are removed from the vessel via a connection using a vacuum pump on the vessel. To prevent the solvent from damaging the vacuum pump, for example, a cold trap can be provided upstream of the vacuum pump. The vacuum to be applied is adapted to the liquids to be vaporized and can also be further adjusted during the process, if required.

The advantage of using such a vacuum centrifuge is that the foaming of the sample (boiling delay) can be reduced by the effect of centrifugal acceleration on the sample.

A disadvantage of the prior art vacuum centrifuges is that they do not allow for an exact control of the sample temperature and an exact temperature control, as it is difficult to measure the temperature of the samples continuously, or to heat the samples in a targeted manner. In addition, the composition of the samples changes permanently with continuous evaporation, which can also change the boiling temperatures. Another problem is that the samples will cool down due to what is referred to as evaporative cooling.

Another serious disadvantage of vacuum centrifugation is that evaporation of the sample is made more difficult by the fact that the liquid sample is not moved in the sample container during centrifugation. As a result, the sample is not continuously mixed, which leads to a temperature gradient (evaporative cooling, particularly on the surface of the sample), moreover, only a small amount of liquid can be evaporated per unit of time over the often small surface area. In case of a moving sample, this surface area and also the evaporation rate would be greater. Especially with samples containing protein and/or salt, a kind of clod formation of precipitating or crystallizing ingredients can also occur on the surface, which is a barrier to the evaporation of the sample liquid, making evaporation even more difficult.

A vacuum centrifuge is known from GB 2 349 108 A, which moves the sample containers relative to the rotor head during centrifugation, in the manner of a dual centrifuge. The disadvantage of this design, however, is the complex structure required to enable the sample containers to be driven in rotary units. Moreover, contamination of the samples by the drive can hardly be prevented.

It is the object of the invention, therefore, to further develop a vacuum centrifuge of the type specified in the preamble of claim 1 in such a way that, on the one hand, the evaporation process during centrifugation is improved without any additional temperature increase, whilst avoiding the abovementioned disadvantages, and, on the other hand, that the centrifuge design is simplified.

This object is accomplished for a vacuum centrifuge by the characterizing features of claim 1 in conjunction with the features of its preamble.

The dependent claims relate to advantageous further embodiments of the invention.

The invention is based on the realization that the centrifuge can be designed more simply by using only one drive motor, and that various protective measures to prevent sample contamination can be dispensed with. Furthermore, the sample container with the sample should be moved additionally during centrifugation, as this is a simple way of increasing the evaporation surface, thus facilitating the evaporation process. Moreover, moving the sample in the sample container equalizes the temperature in the sample, making it easier to apply heat from outside, e.g. by IR light, to the entire sample and equalizing a temperature gradient, e.g. due to evaporative cooling, particularly on the surface of the samples.

The present invention provides for the vacuum centrifuge to have a housing. A vacuum chamber is arranged in the housing, which is connected to a vacuum pump via a suction line system in order to generate a desired vacuum in the vacuum chamber. A rotor is provided in the vacuum chamber, which is mounted in the vacuum chamber so that it can rotate about its rotor axis and has sample container receptacles for inserting sample containers into the vacuum chamber. A cover is fitted to the housing, which closes the vacuum chamber in a vacuum-tight manner and, when open, exposes the rotor sufficiently to allow the rotor to be loaded and unloaded with sample containers. In addition, a drive motor is provided for the rotor, which is preferably arranged outside the vacuum chamber and is coupled to the rotor in the vacuum chamber, for example via a contactless coupling, in order to transmit the drive torque, as part of a first drive mechanism. The rotor is designed as the rotor of a dual centrifuge in such a way that the rotor has a rotor head. The rotor head has at least one rotary unit with at least one sample container receptacle at a distance from the rotor axis. According to the invention, only a single drive motor is provided. This single drive motor is used to effect the movements of the rotor head and of the rotary unit. In the case of a dual rotor, the samples also rotate around their own second axis of rotation. The surface area of the sample exposed to the vacuum is increased by the additional movement and the liquids are also circulated. This improves evaporation. Providing only a single drive simplifies the centrifuge design and also reduces the risk of contamination of the samples through abrasion.

Preferably, the rotary unit can be driven relative to the rotor by mechanical drive forces or by non-mechanical drive forces, for example by magnetic forces, inertial forces or the like. This further simplifies the design and reduces the number of moving parts.

In one embodiment of the invention, the rotary unit is mounted so as to be freely rotatable relative to the rotor. This opens up further design possibilities, particularly for driving the rotary unit using non-mechanical drive forces.

In particular, the rotary unit can be driven by a second drive mechanism. When the second drive mechanism is active, the additional rotary unit rotates around an axis of rotation of the rotary unit.

Preferably, the rotary unit is arranged in a bearing that is connected to the rotor head. The rotary unit is rotatably mounted in the bearing relative to the rotor head and can be driven relative to the rotor head by the second drive mechanism.

In order to prevent contamination of the device and of the samples with lubricants, the pivot bearing is preferably designed as a lubricant-free bearing, e.g. as a plain bearing or a lubricant-free ceramic bearing. The plain bearing is primarily designed to be abrasion-resistant.

In particular, a rotary unit only has a single sample container receptacle for receiving a single sample container. Alternatively, a rotary unit can have several sample container receptacles.

Several rotary units can be provided to increase the performance of the vacuum centrifuge.

In one embodiment of the invention, the second drive mechanism has a second drive element, which is rotatably mounted on the rotor head and can be rotated relative to the rotor head about the rotor axis and about the axis of rotation of the rotary unit. The drive element is coupled to the rotary unit in such a way that, when the drive element is moved relative to the rotor head, the rotary unit will be driven by the drive element. This is a simple way of creating the conditions for the second drive mechanism to be implemented in a contact-free manner, without breakthroughs, i.e. without weakening the vacuum chamber.

For example, the second drive mechanism can be designed as an inertia drive, with the second drive element serving as an inertia element that drives the rotary unit by changing the speed—acceleration or deceleration of the rotor—of the first drive mechanism. The second drive element is part of the second drive mechanism. In the event of a speed change of the first drive mechanism, the second drive element will move relative to the rotor head in the one direction or the other in accordance with this speed change. Simply by changing the rotor head speed, additional movement of the second drive mechanism can be generated by the second drive element.

In one embodiment of the invention, at least one mass element, preferably two or more mass elements, in particular made of metal or a metal alloy, may be mounted on and/or in the second drive element, preferably in a detachable manner. The mass element can also be rotationally symmetrical and arranged concentrically on or in the second drive element. This allows the inertia properties and thus the drive of the second drive mechanism to be adjusted by selecting mass elements having specific weights and geometries.

In addition or as an alternative, a magnetic field can also act on the second drive element. For this purpose, at least one magnetic element can be mounted on the second drive element, which magnetic element interacts with a magnetic field, which is preferably adjustable, in such a way that a relative movement of the second drive element with respect to the rotor head can be generated by the magnetic field interacting with the magnets.

In order to prevent the magnetic field from overlapping with the magnetic coupling of the first drive mechanism to the rotor, the magnetic field acting on the second drive element is arranged at some distance from the first drive mechanism.

In one embodiment of the invention, the second drive element and the rotary unit are drivingly coupled to one another via a gearing or via a friction connection. Alternatively, the second drive element is fixed relative to the rotor head and is drivingly coupled to the rotary unit by means of a gearing or a friction connection. This makes it easy to establish the drive connection between the rotary unit and the drive element.

The rotary unit can preferably also have a recess which serves as a sample container receptacle into which at least one sample container can be introduced.

A lower portion of the sample container, or of a receptacle holding the sample container, can protrude from the rotor head and the rotary unit in an exposed manner. Alternatively, the rotary unit can be designed to protrude downwards in the area of the sample container receptacle.

The rotor head has a rotationally symmetrical basic shape that forms an envelope. The lower area of the sample container protrudes beyond the envelope in order to better absorb the thermal energy from heat radiation in the vacuum chamber.

For this purpose, at least 30%, preferably at least 50%, of the height of the sample container can protrude beyond the envelope of the rotor head. This means that the maximum possible surface area of the sample container should protrude from the rotor head for heat absorption.

An easy way of increasing the surface area of the sample to the vacuum without the sample being urged out of the sample vessel by the centrifugal forces, is to incline the axis of rotation of the rotary unit relative to the rotor axis, typically at an angle in the range from and including 5° up to and including 85°.

In a particular embodiment of the invention, this angle can be freely adjusted in the above-mentioned range or in discrete steps.

In particular, the drive motor and the rotor can be coupled to one another via a contactless coupling. This avoids the time-consuming sealing of the vacuum chamber and further simplifies the design.

According to one aspect, the invention is also characterized by a method for operating a vacuum centrifuge in which the speed of the rotor head, and thus of the rotary unit changes, in particular continuously, during centrifugation, or a constant speed of the rotor and a constant speed of the rotary unit are predetermined. In particular, there is a fixed ratio of rotor speed to rotary unit speed. Depending on the type of drive, the best speed behavior of the rotor head and rotary unit can thus be selected.

Preferably, the direction of rotation of the rotary unit relative to the rotor head also changes during centrifugation, in particular continuously.

In particular, the speed of the rotor head and/or the rotary unit can change, especially continuously, during centrifugation. This makes it easy to activate the inertia drive.

Alternatively or additionally, an adjustable magnetic field is applied, which interacts with magnets arranged on the drive element so that rotation of the second drive element is delayed or released by the magnetic field. This allows the movement of the second drive mechanism to be generated in a simple, contact-free manner.

In particular, there is a reduction or an increase of the rotational movement between the rotor and the rotary unit.

According to one embodiment of the invention, a first rotor and additional rotors are provided, which form a set of rotors. The additional rotors are designed differently to the first rotor with regard to the second drive mechanism of the rotary unit, or they do not have a second drive mechanism. In the latter case, it can also be a rotor that does not form a dual centrifuge. However, only one of the rotors is arranged on the drive shaft at a time.

Preferably, each rotor of this set is provided with a locking mechanism for the drive shaft, in particular a manually operable locking mechanism, preferably a screw mechanism or a quick-release fastener, for receiving and securing one rotor of the set on the drive shaft.

In another aspect, the invention relates to a method for operating a vacuum centrifuge of the type set forth above. This generates a speed of the rotor and/or the rotary unit that changes during centrifugation, in particular continuously. Alternatively, a constant speed can be set for the rotor and a constant speed for the rotary unit, in particular a fixed ratio of the rotor speed to the rotary unit speed.

Preferably, a rotor head speed is generated that changes during centrifugation, in particular for driving the inertia drive of the rotary unit.

In addition, a magnetic field can be set which interacts with at least one magnet arranged on the second drive element so that rotation of the second drive element is delayed or released by the magnetic field. This also results in a changing speed of the rotary unit.

One embodiment of the invention may provide for a reduction or an increase of the rotational movement between the rotor and the rotary unit.

In another aspect, the invention relates to a method for removing liquids from samples in sample containers by evaporation using a vacuum centrifuge. According to the invention, the sample container with the sample is additionally moved during centrifugation. This is a simple way of increasing the evaporation surface. The evaporation process can thus be facilitated. Moreover, moving the sample in the sample vessel equalizes the temperature in the sample, which makes it easier to apply heat from outside, e.g. by IR light, to the entire sample, and equalizes a temperature gradient, e.g. due to evaporative cooling, particularly on the surface of the samples.

In particular, the method is carried out using a vacuum centrifuge and its method of operating the vacuum centrifuge as described in a first aspect of the invention.

The liquid to be removed from the sample is solvents and/or water.

Additional advantages, features and possible applications of the present invention will be apparent from the description which follows, in which reference is made to the embodiments illustrated in the drawings.

Throughout the description, the claims and the drawings, those terms and associated reference signs are used as are stated in the list of reference signs below. In the drawings,

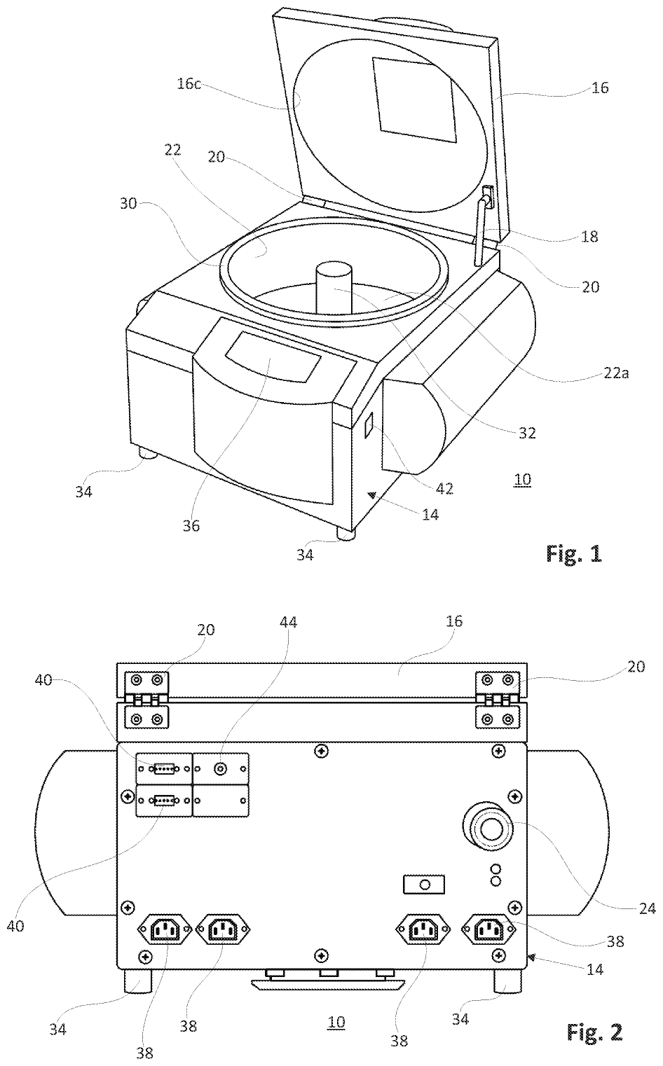

FIG. 1 is a perspective view, taken at an angle from above, of a vacuum centrifuge according to the invention with its cover open;

FIG. 2 is a rear view of the vacuum centrifuge of FIG. 1 with the respective connections;

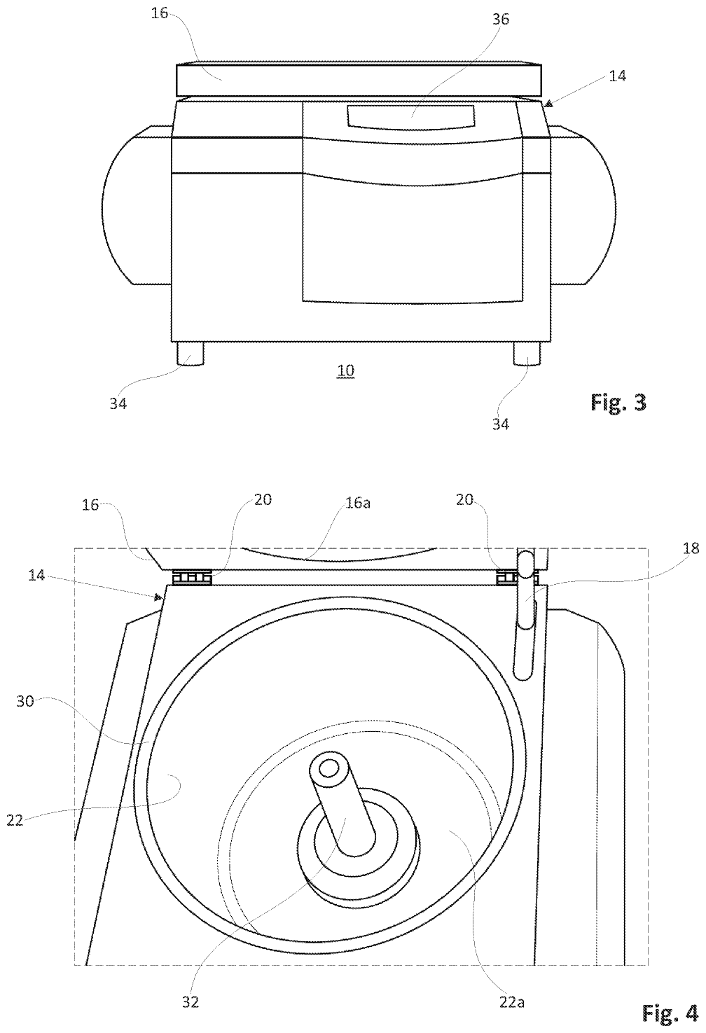

FIG. 3 is a front view of the vacuum centrifuge of FIG. 1;

FIG. 4 is a detail view, taken at an angle from above, of the rotor axis and the vacuum vessel of the vacuum centrifuge of FIG. 1;

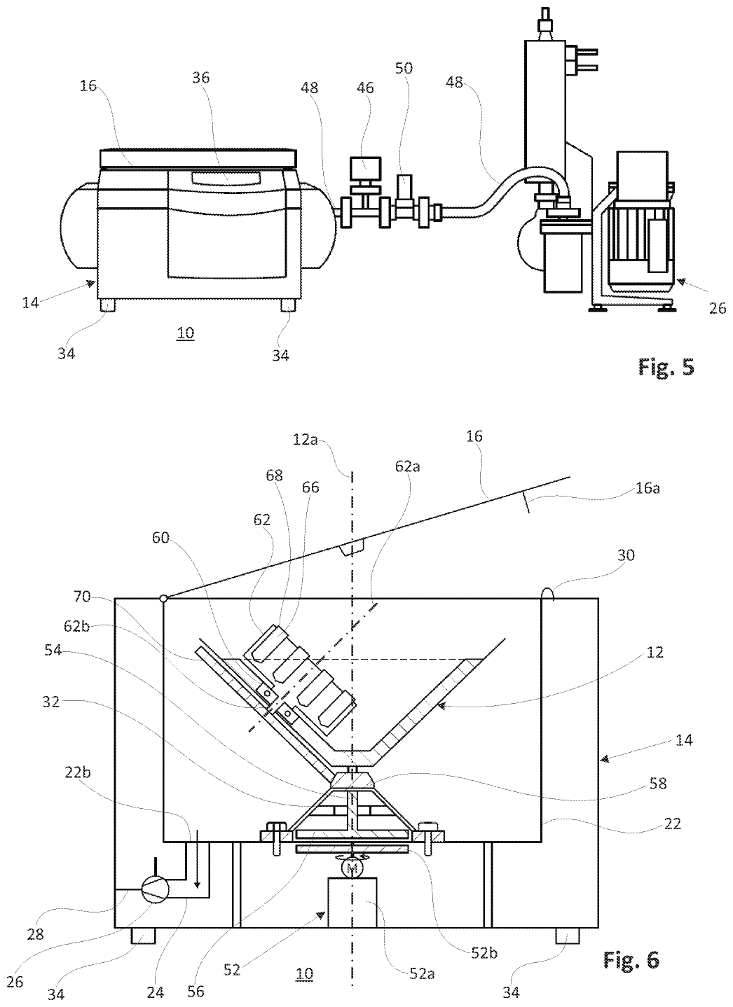

FIG. 5 is a schematic view of the components required to operate the vacuum centrifuge of FIG. 1;

FIG. 6 is a schematic sectional view (of the centrifuge), with the cover open, showing the rotor and a rotary unit connected to the rotor, according to a first embodiment of the invention;

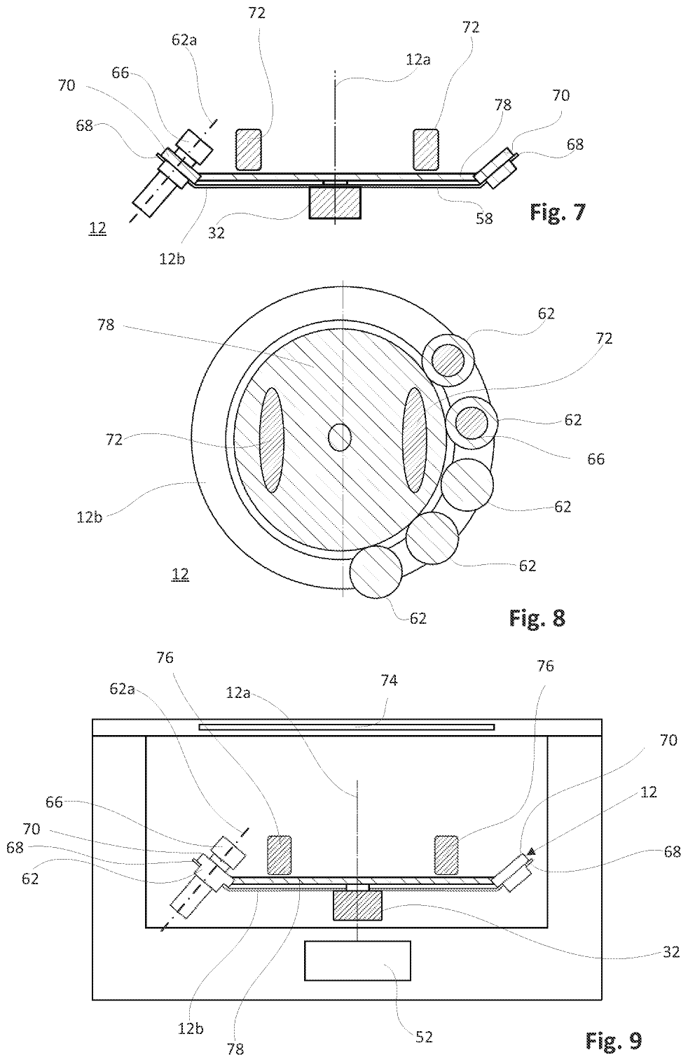

FIG. 7 is a schematic sectional view of the rotor with connected rotary unit, according to a second embodiment of the invention;

FIG. 8 is a top view of the rotor with the rotary unit, as schematically shown in FIG. 7;

FIG. 9 is a schematic sectional view of the rotor with connected rotary unit according to a third embodiment of the invention, and a coil arranged in the cover of the centrifuge for generating a magnetic field;

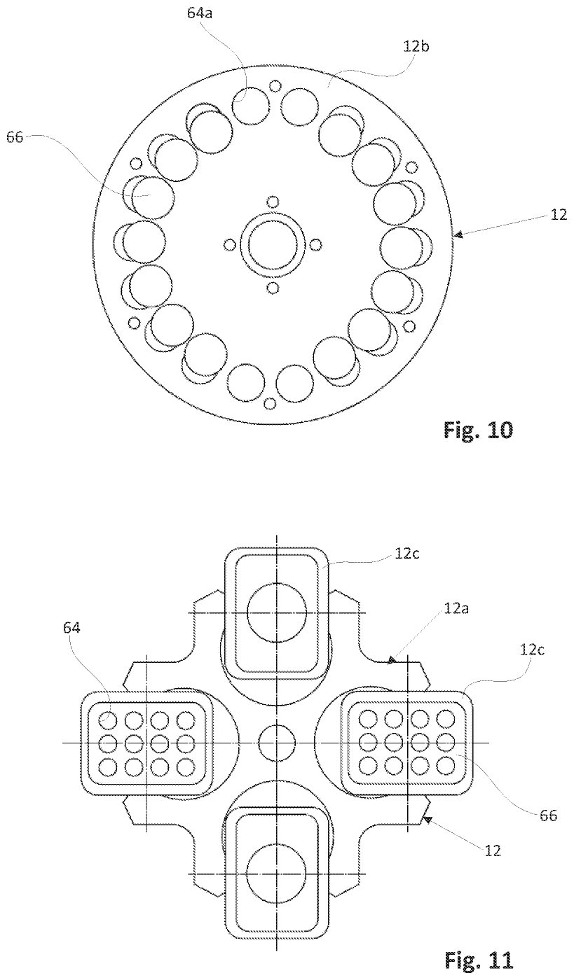

FIG. 10 is an alternative rotor head for mounting on the rotor shaft of FIG. 4, according to another embodiment of the invention, and

FIG. 11 is a further alternative rotor head for mounting on the rotor shaft of FIG. 4, according to another embodiment of the invention.

FIGS. 1 to 11 show a vacuum centrifuge 10 with a rotor 12, according to the invention. The vacuum centrifuge 10 comprises a housing 14 with a cover 16, which is hinged to the housing 14 via a closing and opening mechanism 18 by means of joints 20. The cover 16 closes the vacuum chamber 14a in a vacuum-tight manner. When the centrifuge is open, the rotor 12 is released to an extent that allows loading and unloading of the rotor 12 with sample containers 66.

A safety vessel 22 is arranged in the housing 14, which has an opening 22b in the base 22a, which opening 22b interacts with a vacuum pump 26 via vacuum lines 24. An exhaust duct 28 is connected to the vacuum pump 26. The safety vessel 22 and the cover 16 delimit a vacuum chamber 14a, in which centrifugation with the rotor 12 takes place under vacuum.

The vacuum pump 26 can be arranged outside the housing 14, as is shown in detail in FIG. 5 and described more specifically below, or inside the housing 14, as is shown in FIG. 6.

In the upper region of the safety vessel 22 a seal 30 is provided which interacts with a seal 16a in the cover 16 and ensures a vacuum, if required, within the safety vessel 22 with the cover 16 closed, in that the cover 16 closes the vacuum chamber 14a in a vacuum-tight manner.

A rotor mount 32 is provided on the base 22a of the safety vessel 22, which is designed as an axle or a shaft, depending on the type of rotor drive. For example, if the rotor mount 32 is of a shaft design, the rotor 12 is driven via the rotor mount. Alternatively, if the rotor mount 32 is designed as an axle, the rotor 12 is rotatably mounted on the rotor mount 32 and is driven, for example, by induction, i.e. via magnetic fields. These types of drives are known per se, for which reason they are not described in detail here.

The housing 14 is mounted on feet 34, which are provided underneath the housing 14 in its corner areas. The vacuum centrifuge 10 is switched on and off via a mains switch 42. The operating mode of the vacuum centrifuge 10 is set via a touch display 36. The vacuum centrifuge 10 and the external devices are supplied with power via electrical connections 38, see FIG. 2, as will be explained in detail below with reference to FIG. 5.

Data interfaces 40 are provided for uploading operating programs but also for downloading operating data. In addition, a connection 44 for a vacuum measuring probe 46 is provided on the rear side 10a, via which the vacuum in the safety vessel 22 is regulated by the vacuum pump 26 in cooperation with a control device (not shown here). In addition, a vacuum connection 44 is provided for connecting an additional vacuum line 48 which leads to the external vacuum pump 26. The vacuum connection 44 is connected to the vacuum line 24, which is in turn connected to the opening 22b in the base 22a of the safety vessel 22.

FIG. 5 is a view of the vacuum centrifuge 10 with an external vacuum pump 26. The vacuum pump 26 is connected to the vacuum line 48, which in turn connects the vacuum pump 26 to a shut-off valve 50. Connected to the shut-off valve 50 is the vacuum measuring probe 46, which in turn is connected to the vacuum connection 44 of the vacuum centrifuge 10 via the vacuum line 48.

FIG. 6 is a sectional view of an embodiment of a rotor 12 according to the invention. The rotor 12 is driven by magnetic force coupling. For this purpose, an electric drive 52 is provided outside the safety vessel 22, underneath the base 22a and concentric to a rotor axis 12a. The rotor 12 is driven contactlessly via the electric drive 52 using appropriate magnetic fields. For this purpose, the electric drive 52 has a motor 52a and a magnet 52b driven by the motor 52a. The rotor mount 32 comprises a rotor shaft 54, which has a magnetizable bar 56 in its lower area, which bar 56 runs at right angles to the rotor shaft 54 and is firmly connected to it. The bar 56 is driven via magnetic force coupling by the electric drive 52, whereby the rotor shaft 54 is also driven. The rotor shaft 54 is rotatably mounted in the rotor mount 32.

The rotor mount 32, which is firmly fixed in the safety vessel 22, has a gear wheel 58 arranged to be concentric to the rotor axis 12a, which gear wheel 58 is firmly connected to the rotor mount 32, which in turn is firmly connected to the safety vessel 22. The rotor shaft 54 is rotatably mounted in the rotor mount 32 relative to the gear wheel 58. A rotor head 12b is arranged on the free end of the rotor shaft 54 as part of the rotor 12. The rotor head 12b is funnel-shaped and provided with mounts 60 for rotary units 62. The rotary units 62 have multiple sample container receptacles 64 that are each arranged at a distance from one another, into which sample containers 68 with samples to be treated can be introduced.

The rotary unit 62 is mounted in the rotor head 12b so as to be rotatable about an axis of rotation 62a. For this purpose, the mount 60 has a bearing 68 for the rotary unit 62. The axis of rotation 62a runs perpendicular to the rotor head 12b. Concentric to the axis of rotation 62a, the rotary unit 62 is provided with a drive axle 62b, which extends through the rotor head and is connected to a gear wheel 70 arranged concentrically to the axis of rotation 62a. The gear wheel 70 meshes with the gear wheel 58 that is firmly connected to the rotor mount 32.

If the rotor 12, and hence the rotor head 12a, is driven via the electric drive 52, this will cause the rotor head 12a and thus also the rotary unit 62, to rotate about the rotor axis 12a. The gear wheel 70 meshes along the gear wheel 58, thereby driving the rotary unit 62 relative to the rotor head 12b. This results in a relative movement between the rotary unit 62 and the rotor head 12b.

The vacuum centrifuge 10 is thus designed as a dual centrifuge, which has a first drive mechanism with the electric drive 52, the rotor shaft 54 with the rotor head 12b, in which the rotary unit 62 is mounted, and a second drive mechanism with the rotary unit 62, the bearing 68, the gear wheel 70 connected to the rotary unit 62 and the gear wheel 58 connected to the rotor mount 32. The sample container receptacles 64 are arranged at a distance from the rotor axis 12a. The first drive mechanism causes rotation about the rotor axis 12a, and the second drive mechanism causes rotation about the axis of rotation 62a. There is a reduction in the rotational movement between the first drive mechanism and the second drive mechanism.

The bearing 68 can be designed as a plain bearing or as a ball bearing, in particular as a ceramic ball bearing.

The sample container receptacles 64 are arranged rotationally symmetrically about the axis of rotation 62a.

FIG. 7 is a sectional view, and FIG. 8 is a top view, of an alternative rotor head 12b. The rotor head 12b is provided with multiple bearings 68, in each of which a rotary unit 62 is rotatably mounted and designed to receive only one sample container 66. A rotary unit 62 has only one sample container receptacle 64 each. As a result, the rotor head 12b is flatter overall, and aligned at an angle in its edge area to accommodate the rotary units 62. Above the rotor head 12b, a gear wheel 78 is freely rotatable mounted in the rotor mount 32.

Via the bearing 68, the rotary unit 62 is rotatably mounted in the rotor head 12b and extends through the rotor head 12b. In the upper area, the rotary unit 62 is provided with a gear wheel 70, which is drivingly coupled to the gear wheel 78.

The sample container receptacle 64 is designed as a through-hole so that the sample container 66 protrudes from the bottom of the rotary unit 62. The sample container 66 protrudes by at least 50% of its height from an envelope of the rotor head 12b. The rotary unit 62 with the sample container 66 is arranged in the rotor head 12b at an angle of 45°. The axis of rotation 62a of the rotary unit 62 is aligned accordingly.

On the rotor head 12b of the embodiment illustrated in FIGS. 7 and 8, two metal mass elements 72 are symmetrically and detachably connected to the rotor head 12b. The rotor head 12b of this embodiment, as shown in FIGS. 7 and 8, is driven by an electric drive 52, similar to the embodiment of FIG. 6. The rotor head 12b is thus driven via the electric drive 52 so that the rotor head 12b rotates about the rotor axis 12a. By changing the speed of the rotor head 12b via the electric drive 52, the freely rotatable gear wheel 78 coupled to the gear wheels 70 of the rotary units moves relative to the rotor head 12b, thereby driving the rotary units 62. This leading and lagging of the gearwheel 78 relative to the rotor head is caused by the inertial force generated during acceleration and deceleration, which is amplified by the mass elements 72.

If, for example, the vacuum centrifuge 10 is operated continuously with a changing speed of the rotor 12, this will cause deceleration or acceleration of the gear wheel 78 with the mass elements 72. In this process, the mass elements 72 reinforce the inertia force of the gear wheel 78 so that it leads or lags with respect to the rotor head 12b and drives the rotary units 62. This also increases the inertial forces acting on the samples in the sample containers 66. This causes the samples to be moved in addition to the rotary unit 62.

In addition or alternatively, the direction of rotation of the rotor head 12b, and thus of the rotary unit 62, can also change continuously, which also results in a relative movement between the gear wheel 78 and the rotor head 12b. The resulting inertial forces will also act on the sample, thus moving it additionally.

FIG. 9 is a view of a rotor head 12b which is almost identical to the one illustrated in FIGS. 7 and 8. The only difference is that an electromagnetic device 74 is provided in the cover 16 of the vacuum centrifuge 10, which decelerates and releases the gear wheel 78 via an adjustable magnetic field induced by the electromagnetic device 74. For this purpose, magnetic elements 76 are arranged on the rotor head 12b instead of the two mass elements 72. This allows different speeds of the gear wheel 78 to be generated continuously and thus also inertial forces acting on the sample in the sample container 66. To ensure that the magnetic field generated by the electromagnetic device 74 will not impair the drive of the rotor 12, it is arranged in the cover 16 of the vacuum centrifuge 10. The magnetic elements 76 are permanent magnets. The effect of the magnetic field generated by the electromagnetic device can be adjusted by selecting the size of the permanent magnets 76.

Illustrated in FIG. 10 is an alternative known rotor head 12b, in which the sample container receptacles 64 are introduced directly into the rotor head 12b.

FIG. 11 shows a rotor 12 designed as a swing-out rotor, in which the sample container receptacles 64 are fitted in swivel-mounted rotor units 12c.

The rotors 12 shown in FIGS. 10 and 11 are known rotors 12. These can be used instead of the rotors 12 for dual operation, if required. Depending on the specific application, the user will select the rotor 12 best suited to the application. The user therefore has a set of different rotors 12 at their disposal.

The vacuum centrifuge 10 according to the invention is used to remove liquids from biological, organic or inorganic samples in sample containers by evaporation. Thanks to the vacuum, the boiling temperature of the liquids is reduced. This means that the liquid evaporates at a lower temperature, so that the biological, organic or inorganic samples are not affected at all, or at least to a lesser extent. In addition, the liquids evaporate more quickly. The centrifugal forces that occur during vacuum centrifugation counteract the so-called foaming of the samples.

The samples normally consist of liquids in which socovers are dissolved and/or dispersed. The liquids can be volatile or semi-volatile organic solvents, water, or a mixture of the aforementioned, which are vaporized in a vacuum. After filling the sample containers, such as test tubes or plastic vials, with the samples, these are placed in the rotor 12 of the vacuum centrifuge 10, rotation is started, and the desired vacuum is generated in the vacuum chamber 14a. The vessel is continuously evacuated with the vacuum pump 26 in order to remove the evaporated liquid from the vacuum chamber 14a and maintain the desired vacuum despite the evaporation. During centrifugation, the solvents and/or the water evaporate and are removed from the vacuum chamber 14a via the opening 22b in the base 22a, the vacuum line 24 and the exhaust duct 28 by means of the vacuum pump 26. The vacuum to be applied is adjusted to the liquids to be vaporized, and can also be further adjusted during the process, if required.

Moreover, the vacuum centrifuge 10 can be equipped with a heater to control the temperature of the rotor 12 and of the sample containers 66 with the samples arranged inside them. Among other things, radiant heaters are known, such as light with a high IR component, which radiate through a transparent cover into the vacuum chamber containing the samples. For reasons of clarity, this heater is not shown in the drawings. Moreover, such heaters are known.

During centrifugation, the vacuum centrifuge 10 according to the invention not only moves the sample containers 66 about the rotor axis 12a, but also about the axis of rotation 62a of the rotary unit 62. This is a simple way of increasing the evaporation surface and thus facilitating the evaporation process. In addition, the temperature in the sample is equalized by moving the sample in the sample container 66.

### LIST OF REFERENCE SIGNS

10 vacuum centrifuge
10a rear of vacuum centrifuge 10
12 rotor
12a rotor axis
12b rotor head
12c rotor unit
14 housing
14a vacuum chamber
16 cover of vacuum centrifuge 10
16a seal in cover 16
18 closing mechanism
20 joint
22 safety vessel
22a base of safety vessel 22
22b opening in floor 22a
24 vacuum line
26 vacuum pump
28 exhaust duct
30 seal in upper edge of safety vessel 22
32 rotor mount
34 foot of housing 14
36 touch display
38 electrical connection
40 data interface
42 mains switch
44 connection for vacuum measuring probe 46
46 vacuum measuring probe
48 vacuum line
50 shut-off valve
52 electric drive
52a motor of electric drive 52
52b magnetic bar of electric drive 52
54 rotor shaft
56 magnetic bar of rotor 12
58 gear wheel connected to rotor mount 32
60 rotary unit 62 mount
62 rotary unit
62a axis of rotation
62b drive axle
64 sample container receptacle
66 sample container
68 bearing for rotary unit 62
70 gear wheel
72 mass element
74 electromagnetic device
76 magnetic element, permanent magnet
78 gear wheel

1. A vacuum centrifuge having a housing, a vacuum chamber which is disposed in the housing and is connected to a vacuum pump via a suction line system in order to generate a desired vacuum in the vacuum chamber, a rotor, which is mounted rotatably about its rotor axis in the vacuum chamber and is provided with sample container receptacles for the introduction of sample containers into the sample container receptacles, a cover which is disposed on the housing, closes the vacuum chamber in a vacuum-tight manner and, in the open state, frees the rotor sufficiently to enable loading and unloading of the rotor with sample containers, a drive motor for the rotor, which is disposed outside the vacuum chamber and is coupled to the rotor in the vacuum chamber for transmission of the driving torque as part of a first drive mechanism, which rotor is designed as a rotor of a dual centrifuge in such a way that the rotor has a rotor head which is provided with at least one rotary unit with at least one sample container receptacle disposed at a distance from the rotor axis, wherein only one drive motor is provided.

2. A vacuum centrifuge according to claim 1, wherein the rotary unit can be driven relative to the rotor by one of mechanical drive forces or by non-mechanical drive forces, via magnetic forces, and inertial forces.

3. A vacuum centrifuge according to, claim 1, wherein the rotary unit is mounted so as to be freely rotatable relative to the rotor.

4. A vacuum centrifuge according to claim 1, wherein the rotary unit can be driven via a second drive mechanism, which rotary unit rotates about an axis of rotation of the rotary unit when the second drive mechanism is active.

5. A vacuum centrifuge according to claim 4, wherein the rotary unit is arranged in a bearing which is connected to the rotor head, which rotary unit is mounted rotatably relative to the rotor head in the bearing and can be driven relative to the rotor head via the second drive mechanism.

6. A vacuum centrifuge according to claim 5, wherein the bearing is designed as a plain bearing or as a ball bearing, in particular as a ceramic ball bearing.

7. A vacuum centrifuge according to claim 1, wherein the second drive mechanism has a second drive element, which is mounted on the rotor head and is rotatable relative to the rotor head about the rotor axis and about the axis of rotation of the rotary unit, wherein the second drive element is coupled to the rotary unit in such a way that when the second drive element is moved relative to the rotor head, the rotary unit is driven by the second drive element.

8. A vacuum centrifuge according to claim 7, wherein the second drive mechanism is an inertia drive and the second drive element serves as an inertia element which drives the rotary unit by changing the speed—accelerating or decelerating—of the first drive mechanism, which second drive element moves correspondingly in one direction or the other when the speed of the first drive mechanism changes relative to the rotor head.

9. A vacuum centrifuge according to claim 8, wherein at least one mass element, in particular made of metal or a metal alloy, is mounted, detachably, on and/or in the drive element.

10. A vacuum centrifuge according to claim 7, wherein at least one magnetic element is mounted, in particular detachably, on the drive element, which magnetic element interacts with an adjustable magnetic field in such a way that a relative movement of the drive element with respect to the rotor head can be generated by the magnetic field in interaction with the magnetic element.

11. A vacuum centrifuge according to claim 10, wherein the magnetic field is disposed remote from the first drive mechanism.

12. A vacuum centrifuge according to claim 1, wherein the sample container receptacle of the rotary unit is formed by a recess into which at least one sample container is introduced.

13. A vacuum centrifuge according to claim 11, wherein a lower region of the sample container protrudes freely from the rotor head and the rotary unit, or a receiving container for the sample container, which is introduced into the recess, protrudes therefrom.

14. A vacuum centrifuge according to claim 1, wherein a rotationally symmetrical basic shape of the rotor head, which forms an envelope, wherein the lower region of the sample container protrudes beyond the envelope.

15. A vacuum centrifuge according to claim 13, wherein at least 30%, preferably at least 50%, of the height of the sample container protrudes beyond the envelope of the rotor head.

16. A vacuum centrifuge according to claim 1, wherein the axis of rotation of the rotary unit is inclined relative to the rotor axis, preferably at an angle in the range from and including 5° to up to and including 85°.

17. A vacuum centrifuge according to claim 1, wherein a first rotor and additional rotors are provided, which form a set of rotors, the additional rotors being designed differently from the first rotor with respect to the second drive mechanism of the rotary unit, or having no second drive mechanism, with only one of the rotors being disposed on the drive shaft at any one time.

18. A vacuum centrifuge according to claim 17, wherein each rotor of this set has a locking mechanism for the drive shaft, preferably a manually operable locking mechanism, in particular a screw mechanism or a quick-release fastener, for receiving and fixing a rotor of the set on the drive shaft.

19. A method for operating a vacuum centrifuge using a vacuum centrifuge having a housing, a vacuum chamber which is disposed in the housing and is connected to a vacuum pump via a suction line system in order to generate a desired vacuum in the vacuum chamber, a rotor, which is mounted rotatably about its rotor axis in the vacuum chamber and is provided with sample container receptacles for the introduction of sample containers into the sample container receptacles, a cover which is disposed on the housing, closes the vacuum chamber in a vacuum-tight manner and, in the open state, frees the rotor sufficiently to enable loading and unloading of the rotor with sample containers, a drive motor for the rotor, which is disposed outside the vacuum chamber and is coupled to the rotor in the vacuum chamber for transmission of the driving torque as part of a first drive mechanism, which rotor is designed as a rotor of a dual centrifuge in such a way that the rotor has a rotor head which is provided with at least one rotary unit with at least one sample container receptacle disposed at a distance from the rotor axis, wherein only one drive motor is provided, wherein a speed of the rotor and/or the rotary unit which changes during centrifugation continuously, or a constant speed of the rotor and a constant speed of the rotary unit, a fixed ratio of the rotor speed to the rotary unit speed.

20. A method according to claim 19, wherein the second drive mechanism has a second drive element, which is mounted on the rotor head and is rotatable relative to the rotor head about the rotor axis and about the axis of rotation of the rotary unit, wherein the second drive element is coupled to the rotary unit in such a way that when the second drive element is moved relative to the rotor head, the rotary unit is driven by the second drive element,
The second drive mechanism is an inertia drive and the second drive element serves as an inertia element which drives the rotary unit by changing the speed—accelerating or decelerating—of the first drive mechanism, which second drive element moves correspondingly in one direction or the other when the speed of the first drive mechanism changes relative to the rotor head, and
a changing speed of the rotor head during centrifugation, for driving the inertia drive of the rotary unit.

21. A method according to claim 19, wherein an adjustable magnetic field which interacts with at least one magnet disposed on the second drive element, resulting in the rotary movement of the second drive element being delayed or released by the magnetic field.

22. A method for removing liquids from samples in sample containers by evaporation using a vacuum centrifuge, wherein the sample container with the sample is additionally moved during centrifugation.

23. A method according to claim 22, wherein the method is performed using a vacuum centrifuge having a housing, a vacuum chamber which is disposed in the housing and is connected to a vacuum pump via a suction line system in order to generate a desired vacuum in the vacuum chamber, a rotor, which is mounted rotatably about its rotor axis in the vacuum chamber and is provided with sample container receptacles for the introduction of sample containers into the sample container receptacles, a cover which is disposed on the housing, closes the vacuum chamber in a vacuum-tight manner and, in the open state, frees the rotor sufficiently to enable loading and unloading of the rotor with sample containers, a drive motor for the rotor, which is disposed outside the vacuum chamber and is coupled to the rotor in the vacuum chamber for transmission of the driving torque as part of a first drive mechanism, which rotor is designed as a rotor of a dual centrifuge in such a way that the rotor has a rotor head which is provided with at least one rotary unit with at least one sample container receptacle disposed at a distance from the rotor axis, wherein only one drive motor is provided, and
a speed of the rotor and/or the rotary unit which changes during centrifugation continuously, or a constant speed of the rotor and a constant speed of the rotary unit, a fixed ratio of the rotor speed to the rotary unit speed.

24. A method according to claim 22 wherein the liquid to be removed is solvents and/or water.
